(19) United States
(12) Patent Application Publication
(10) Pub. No.: US 2022/0187798 A1
(43) Pub. Date: Jun. 16, 2022

(54) MONITORING SYSTEM FOR ESTIMATING USEFUL LIFE OF A MACHINE COMPONENT

(71) Applicants: University of Cincinnati, Cincinnati, OH (US); Mazak Corporation, Florence, KY (US)

(72) Inventors: Moslem Azamfar, Cincinnati, OH (US); Vibhor Pandhare, Cincinnati, OH (US); Marcella Miller, Cincinnati, OH (US); Fei Li, Cincinnati, OH (US); Pin Li, Cincinnati, OH (US); Jaskaran Singh, Cincinnati, OH (US); Hossein Davari, Cincinnati, OH (US); Jay Lee, Mason, OH (US); Joseph Frank Sanders, JR., Erlanger, KY (US); Keita Yamaguchi, Aichi (JP)

(73) Assignees: University of Cincinnati, Cincinnati, OH (US); Mazak Corporation, Florence, KY (US)

(21) Appl. No.: 17/551,648

(22) Filed: Dec. 15, 2021

Related U.S. Application Data
(60) Provisional application No. 63/125,544, filed on Dec. 15, 2020.

(51) Int. Cl. G05B 19/418

(52) U.S. Cl. CPC G05B 19/4184; G05B 2219/37252

(57) ABSTRACT

Systems, methods, and computer program products for remaining useful life prediction. Operational data is collected from a test machine until a component fails, and a training dataset generated from the operational data. The training dataset is used to define and validate a prediction model. Operational data received from one or more field machines is provided to the prediction model. The prediction model then predicts the remaining useful life of the component of the field machine. To reduce the time-to-failure of the component in the test machine, the component may be repeatedly subjected to an accelerated wear cycle. The prediction model may be defined by extracting features from the training dataset. Like features may be extracted from the field dataset and provided to the prediction model as part of the prediction process. The operational data received from the field machines may be used to generate an updated prediction model.

### CROSS-REFERENCE TO RELATED APPLICATIONS

The present application claims the filing benefit of co-pending U.S. Provisional Application Ser. No. 63/125,544, filed Dec. 15, 2020, the disclosure of which is incorporated by reference in its entirety.

### FIELD OF THE INVENTION

The present invention relates generally to machine monitoring and, more particularly, to systems, methods, and computer program products for estimating the remaining life of a component of a machine.

### BACKGROUND

A significant concern in the manufacturing industry is production downtime due to maintenance, inspection, and repair of machines. This downtime impacts both productivity and the cost of ownership of assets used for production. Conventional approaches to avoiding downtime include proactively replacing parts during scheduled downtimes based on the amount of use. However, this approach typically leads to early replacement of parts that have a significant amount of remaining operational life, or fails to replace parts that fail early due to random variations or manufacturing defects. In either case, proactive maintenance fails to optimize cost by only replacing parts that won't last to the next scheduled downtime. Thus, the ability to detect degradation and predict remaining useful life of machines and their components without interrupting production could reduce downtime due to unscheduled maintenance, and reduce the frequency of scheduled downtime.

Thus, there is a need for improved systems, methods, and computer program products that monitor the condition of machines and their components during operation, and provide users with information regarding their condition and remaining useful life.

### SUMMARY

The present invention overcomes the foregoing and other shortcomings and drawbacks of systems, methods, and computer program products heretofore known for use in monitoring machines. While the present invention will be discussed in connection with certain embodiments, it will be understood that the present invention is not limited to the specific embodiments described herein.

In an embodiment of the invention, a system for estimating a health of a machine is provided. The system includes one or more processors, and a memory coupled to the one or more processors that includes program code. The program code is configured so that, when it is executed by the one or more processors, the program code causes the system to collect first operational data from a first machine, determine a measured health value based on the first operational data, compare the measured health value to a predicted health value generated by a first prediction model, and determine an error based at least in part on the comparison of the measured health value to the predicted health value. In response to the error exceeding a predetermined threshold, the program code causes the system to define a second prediction model based on the first operational data, and replace the first prediction model with the second prediction model.

In an aspect of the invention, the first machine may be one of a plurality of machines, and the program code may further cause the system to generate the measured health value for each machine of the plurality of machines based on the first operational data from the respective machine, compare each of the measured health values to a respective predicted health value generated by the first prediction model, and determine the error based on each of the comparisons between the measured health values and the predicted health values.

In another aspect of the invention, the error may be a root mean square error.

In another aspect of the invention, each machine may be monitored constantly over time to capture a natural degradation of one or more components.

In another aspect of the invention, a network of machines may be created to share data through a central server.

In another aspect of the invention, the central server may be used for performance assessment, construction of new degradation patterns, and for updating the first prediction model.

In another aspect of the invention, a set of peer-to-peer comparisons and real-time tests may be conducted to assess data or model drift.

In another aspect of the invention, a data and model governance system may be used to update the degradation pattern and first prediction model within a network of machines in real-time and autonomously.

In another aspect of the invention, a notification and management module may be used for user interactions, publishing notifications, and for organizing the analytic queries to a dashboard.

In another aspect of the invention, the program code may further cause the system to operate the first machine in a predetermined manner, collect second operational data from the first machine, and compare the second operational data to a failure criterion. In response to the second operational data not satisfying the failure criterion, the program code may cause the system to perform an accelerated wear cycle on a first component of the first machine, and in response to the second operational data satisfying the failure criterion, the program code may cause the system to generate a training dataset based on the second operational data. The program code further causes the system to iteratively operate the first machine in the predetermined manner, collect the second operational data from the first machine, compare the second operational data to the failure criterion, and perform the accelerated wear cycle until the second operational data satisfies the failure criterion.

In another aspect of the invention, the first machine may include a motor and a spindle, and operating the first machine in the predetermined manner may include causing the motor to rotate the spindle at a predetermined speed.

In another aspect of the invention, the second operational data may include data indicative of one or more of a vibration, a power consumption of the motor, a speed of the motor, an amount of torque generated by the motor, a position of the spindle, a movement of the spindle, and a force applied to the spindle.

In another aspect of the invention, the failure criterion may include detecting one or more of a vibration having an amplitude that exceeds an amplitude threshold, a frequency content that matches a specified frequency content, and a waveform that matches a specified wavelet.

In another aspect of the invention, the program code may cause the system to perform the accelerated wear cycle on the first component by applying a force to the spindle.

In another aspect of the invention, the force may be applied by striking the spindle with a hammer.

In another aspect of the invention, the program code may further cause the system to extract one or more features from the training dataset, and define the first prediction model based on the one or more features.

In another aspect of the invention, the one or more features extracted from the training dataset may include one or more of a frequency domain feature, a time domain feature, and a time-frequency domain feature.

In another aspect of the invention, the program code may further cause the system to operate a second machine, collect third operational data from the second machine, extract the one or more features from the third operational data, and input the one or more features extracted from the third operational data into the first prediction model to estimate a remaining useful life of a second component of the second machine.

In another embodiment of the invention, a method of estimating the health of the machine is provided. The method includes collecting the first operational data from the first machine, determining the measured health value based on the first operational data, comparing the measured health value to the predicted health value generated by the first prediction model, and determining the error based at least in part on the comparison of the measured health value to the predicted health value. In response to the error exceeding the predetermined threshold, the method defines the second prediction model based on the first operational data, and replaces the first prediction model with the second prediction model.

In an aspect of the invention, the first machine is one of the plurality of machines, and the method further includes generating the measured health value for each machine of the plurality of machines based on the first operational data from the respective machine, comparing each of the measured health values to the respective predicted health value generated by the first prediction model, and determining the error based on each of the comparisons between the measured health values and the predicted health values.

In another aspect of the invention, the method may further include operating the first machine in the predetermined manner, collecting the second operational data from the first machine, and comparing the second operational data to the failure criterion. In response to the second operational data not satisfying the failure criterion, the method may perform the accelerated wear cycle on the first component of the first machine. In response to the second operational data satisfying the failure criterion, the method may generate the training dataset based on the second operational data. The method may further include iteratively operating the first machine in the predetermined manner, collecting the second operational data from the first machine, comparing the second operational data to the failure criterion, and performing the accelerated wear cycle until the second operational data satisfies the failure criterion.

In another aspect of the invention, performing the accelerated wear cycle on the first component may include applying the force to the spindle.

In another aspect of the invention, the method may further include extracting the one or more features from the training dataset, and defining the first prediction model based on the one or more features.

In another aspect of the invention, the method may further include operating the second machine, collecting the third operational data from the second machine, extracting the one or more features from the third operational data, and inputting the one or more features extracted from the third operational data into the first prediction model to estimate the remaining useful life of the second component of the second machine.

In another aspect of the invention, the first and second components may be spindle bearings.

In another embodiment of the invention, a computer program product for estimating the health of the machine is provided. The computer program product includes a non-transitory computer-readable storage medium, and program code stored on the non-transitory computer-readable storage medium. The program code is configured so that, when executed by one or more processors, the program code causes the one or more processors to collect the first operational data from the first machine, determine the measured health value based on the first operational data, compare the measured health value to the predicted health value generated by the first prediction model, and determine the error based at least in part on the comparison of the measured health value to the predicted health value. In response to the error exceeding the predetermined threshold, the program code causes the one or more processors to define the second prediction model based on the first operational data, and replace the first prediction model with the second prediction model.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an operating environment including a monitoring system and a machine monitored by the monitoring system.

FIG. 2A is a diagrammatic view of a network architecture for connecting a plurality of monitoring systems to a computing system including a central database and an analytic engine.

FIG. 2B is a diagrammatic view showing additional details of the analytic engine of FIG. 2A.

FIG. 3 is a flowchart of a process for performing an accelerated run-to-failure test on a component of the machine of FIG. 1.

FIG. 4 is a flowchart of a process for using operational data collected from the machine of FIG. 1 to build a prediction model and provide a remaining useful life prediction for the monitored component.

FIG. 5 is a diagrammatic view of a process for pre-processing signals received from sensors in the machine of FIG. 1.

FIG. 6 is a diagrammatic view of a process for extracting features from the pre-processed signals of FIG. 5.

FIG. 7 is a graphical view illustrating a Self-Organizing Map/Minimum Quantization Error (SOM-MQE) based analysis of operational data collected during an accelerated run-to-failure test conducted in accordance with the process of FIG. 3.

FIG. 8 is a graphical view illustrating an analytic engine/remaining useful life prediction.

FIG. 9 is a diagrammatic view of a computer that may be used to implement one or more features depicted by FIGS. 1-8.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding. In particular, thin features may be thickened, for example, for clarity or illustration.

### DETAILED DESCRIPTION

Embodiments of the present invention include systems, methods, and computer program products for predicting a remaining useful life of a machine component, such as a spindle bearing. The ability to predict a time-to-failure for the machine component may enable maintenance activities to be scheduled at a convenient time, such as during a planned shutdown prior to the time predicted. To this end, a monitoring system may collect a training dataset on the machine component. Collecting the training dataset may include collecting operational data during a run-to-failure test of the machine component. Collecting this operational data may include use of an accelerated life test, or any other suitable method of obtaining operational data. For example, an accelerated run-to-failure test may be conducted to acquire operational data on the component to be monitored. This operational data may then be used for model training.

Operational data may include data indicative of vibration, power consumption (e.g., current or voltage), a position or movement of a workpiece or cutting tool, force applied by the workpiece or cutting tool, or any other suitable operational data. Operational data may be collected continuously or on demand by a data acquisition device that receives signals generated by specific sensors. An analytic engine may be used to preprocess signals received by the data acquisition device, extract features from the preprocessed signals, and develop analytic tools for predicting the remaining useful life of the machine component. The analytic tools may include any tools that can be utilized for this specific application, including but not limited to self-organizing map/minimum quantization error (SOM-MQE) tools, as well as other machine learning and Deep Learning tools. Embodiments of the present invention may also include a dashboard for visualization of the analytic results and for providing a user interface to the monitoring system. A network architecture may be used for monitoring different assets through a single dashboard. A central database may be configured to receive, store, and organize operational data, datasets, and prediction models for big data storage, model exchange, advanced analysis, models update, etc. The ability to monitor multiple machines through the dashboard and central database may facilitate peer-to-peer comparisons as well as collaborative model building and refinements.

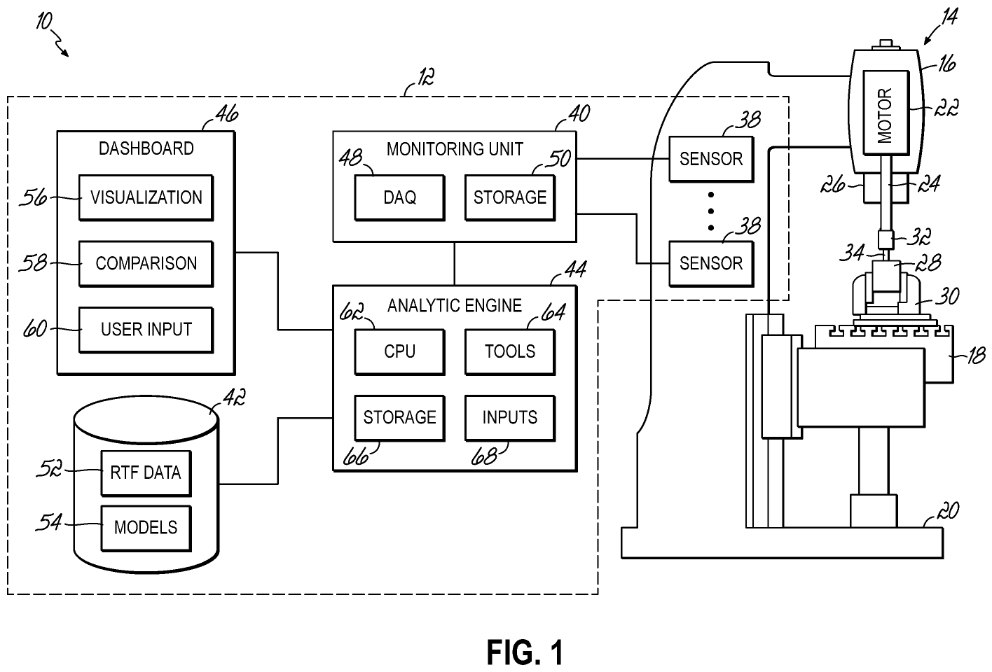

FIG. 1 depicts an exemplary operating environment 10 for a monitoring system 12 that monitors a machine 14 (e.g., a machine tool) in accordance with an embodiment of the present invention. The exemplary machine 14 may include a machine head 16 and a table 18 that are operatively coupled to a frame 20. The machine head 16 may include a motor 22 operatively coupled to a spindle 24, and a spindle bearing 26 that allows the spindle 24 to rotate about an axis of the machine head 16. A workpiece 28 may be operatively coupled to the table 18 by a holder 30, e.g., a vise or clamp. The spindle 24 may include a tool holder 32 configured to receive a cutting tool 34. The cutting tool 34 may be configured to machine the workpiece 28 by selectively removing material therefrom to produce a product. The table 18 may be configured to move in one or more directions (x, y, z) or rotate along one or more axes (α, β, γ) relative to the frame 20 such that the workpiece 28 selectively engages the cutting tool 34. Although the exemplary machine 14 is depicted as a vertical cutting machine, embodiments of the invention are not so limited. Thus, it should be understood that other types of machines may be used, such as a horizontal cutting machine. In addition, the relative movement between the workpiece 28 and the cutting tool 34 may be achieved by moving the workpiece 28, the cutting tool 34, or both the workpiece 28 and the cutting tool 34 relative to a stationary frame of reference, e.g., the frame 20 of machine 14.

The monitoring system 12 may include one or more sensors 38, a monitoring unit 40, a historical information database 42, an analytic engine 44, and a dashboard 46. The one or more sensors 38 may be configured to generate signals indicative of a position, orientation, or movement of the table 18 relative to the cutting tool 34, power consumption or output of the motor 22 (e.g., voltage, current, torque, or rotational velocity), vibration in or proximate to the spindle bearing 26, the force or feed rate with which the cutting tool 34 is engaging the workpiece 28, or any other suitable operational parameter of the machine 14. Sensors 38 may be installed on the equipment specifically for the purpose of generating data for the monitoring system 12, or may be part of a system normally included in the machine 14, such as for controlling the machine 14. Additional operational parameters may be provided to the monitoring system 12 by the user, such as the material from which the workpiece 28 is made, the type of cutting tool 34 or cutting lubricant being used, or any other suitable operational parameters. In an embodiment of the invention, the monitoring system 12 may receive a vibration signal from the spindle 24 with a predefined sampling frequency while the spindle 24 is rotating at a specific rotational speed during offline operation of the machine 14.

The monitoring unit 40 may include a data acquisition module 48 and a storage module 50. The data acquisition module 48 may be configured to receive signals generated by the sensors 38, and output data indicative of information provided by the signals. For example, the data acquisition module 48 may sample each signal received from a respective sensor 38, and convert each sample from an analog value (e.g., a voltage or current) to a digital value (e.g., a binary number). These digital values may comprise digital data indicative of the value of the sampled analog signal at the sampling time, and thus define a characteristic of the operational parameter monitored by the sensor 38. This digital data may be stored locally in the storage module 50 (which may act as a memory buffer), transmitted to the analytic engine 44, or both stored locally and transmitted to the analytic engine 44.

The historical information database 42 may include run-to-failure data 52, and prediction models 54. The prediction models 54 may comprise neural network or other machine learning models that have been trained, at least in part, using the run-to-failure data 52. The prediction models 54 may thereby be configured to provide a predicted time-to-failure for the machine component (e.g., the spindle bearing 26) based on operational parameter data received from the monitoring unit 40.

The dashboard 46 may provide a user interface for the monitoring system 12, and may include a visualization module 56, a comparison module 58, and a user input module 60. The visualization module 56 may be configured to present analytic results received from the analytic engine 44 for display to a system user. The comparison module 58 may be configured to allow the user to compare analytic results received at different times or generated for different machines 14. The user input module 60 may be configured to receive user input, such as commands for selecting data for visualization or comparison. The dashboard 46 may thereby provide a simple and user-friendly user interface for visualization, model updates, and adjustments.

The analytic engine 44 may be responsible for analyzing operational data and generating time-to-failure predictions. To this end, the analytic engine 44 may include a central processing unit 62, analytic tools 64, data storage 66, and inputs 68. The analytic tools 64 may include different tools, such as tools that enable the use of self-organizing maps and mean quantization errors. The inputs 68 may include, for example, operational data received from the monitoring unit 40, run-to-failure data 52 or prediction models 54 received from the historical information database 42, or user input received from the dashboard 46.

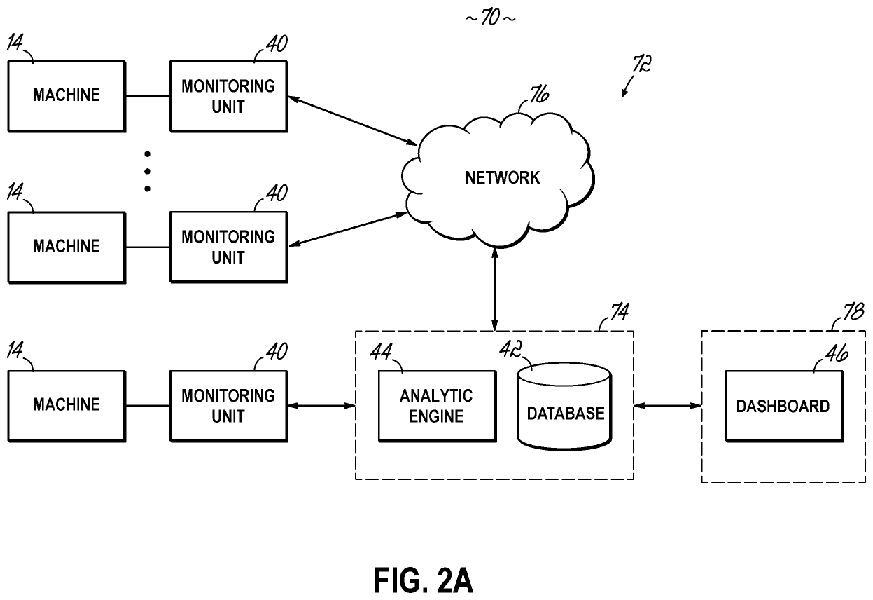

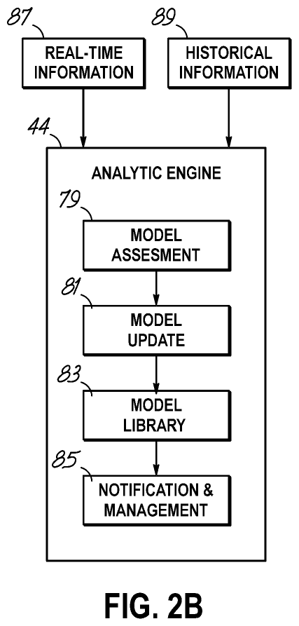

FIG. 2 depicts another exemplary operating environment 70 in accordance with an embodiment of the present invention. The operating environment 70 includes a monitoring system 72 configured to monitor a plurality of machines 14. Each machine 14 may be in communication with a respective monitoring unit 40 that collects operational data from the machine 14. The monitoring units 40 may be in communication with a computing system 74 (e.g., an edge computing system) that hosts the historical information database 42 and analytic engine 44. Each monitoring unit 40 may thereby upload operational data to the historical information database 42 or analytic engine 44, either through an external network 76 (e.g., the Internet) or a local connection. The historical information database 42 may provide a central hub for data storage and prediction models 54 based on operational data received from multiple monitoring units 40. A computing device 78 (e.g., a desktop computer, laptop computer, tablet computer, or smart phone of a system user) may be communication with the computing system 74, and may host an application that provides the dashboard 46. The monitoring system 72 may thereby connect a network of machines 14 to each other for data storage, prediction model updates and exchanges, peer-to-peer comparison, etc.

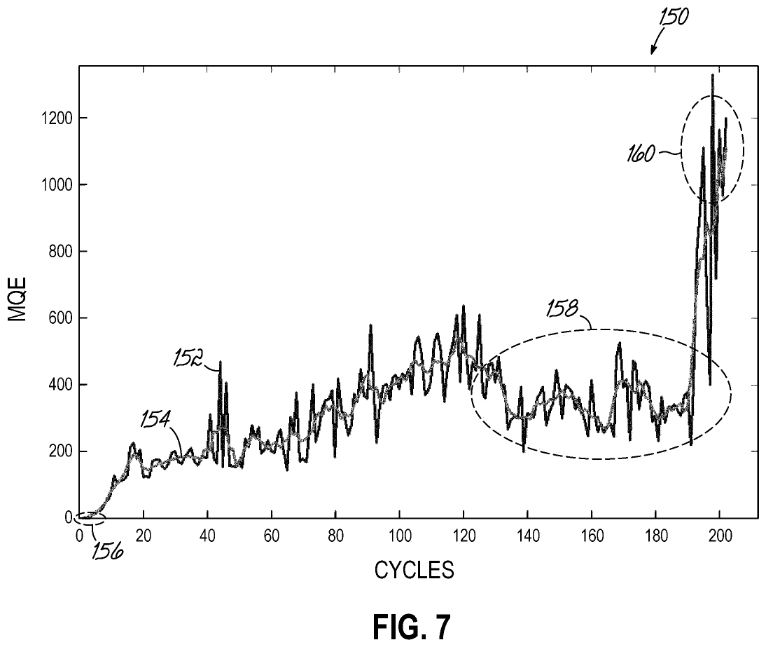

The historical information database 42 may be used to aggregate operational data from multiple machines 14, each of which may be operating under a different health condition. This operational data may be used to generate a life cycle trajectory for one or more of the machines 14, such as the exemplary life cycle trajectory depicted by FIG. 7. The analytic engine 44 may utilize life cycle trajectories from multiple machines 14 to define a global prediction model 54. Moreover, the analytic engine 44 may constantly assess the performance of the prediction model 54 over time to see if the prediction model 54 needs updating. If so, the analytic engine 44 may automatically use a subset of the life cycle trajectories to update an existing prediction model 54 or define a new prediction model 54.

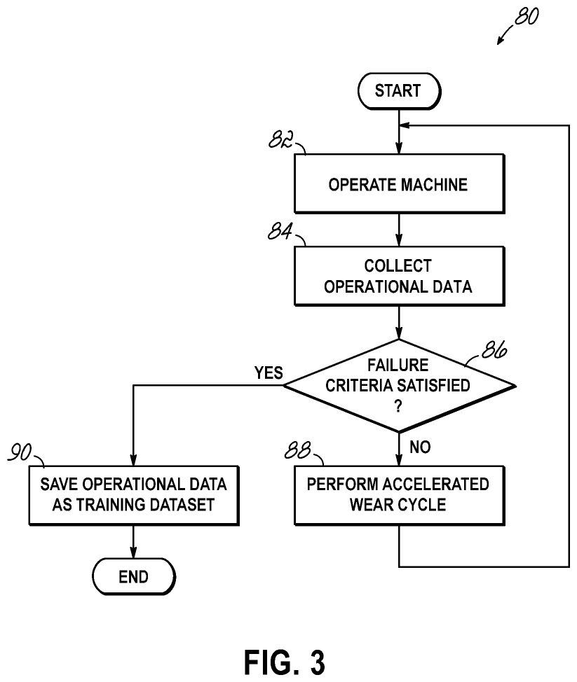

The life cycle data may comprise operational data collected during the normal operation of each machine 14 over the life of the cutting tool 34 or any other component of the machine 14. This life cycle data may be similar to life cycle data obtained through an accelerated life cycle test, e.g., a hammering process such as described below with respect to FIG. 3. The initial prediction model 54 may be built based on accelerated life cycle test, and the subsequent models may be generated automatically through peer-to-peer comparison and using natural degradation patterns collected over time. Through this process, embodiments of the monitoring system 72 may provide automatic updates and sustainable models that handle data and model drift over time.

Referring now to FIG. 2B, the analytic engine 44 may include a prediction model assessment module 79, a prediction model update module 81, a prediction model library 83, and a notification and management module 85. The analytic engine 44 may receive operational data in the form of real-time information 87 and historical information 89, e.g., from one or more of the monitoring units 40 and the historical information database 42. The analytic engine 44 may thereby monitor multiple machines 14 from a central location, aggregate operational data from the machines 14 over their respective life cycles, perform peer-to-peer comparisons, and automatically update the prediction models 54 based on the operational data collected.

The model assessment module 79 may perform a series of tests on the operational data received from the monitoring units 40 and historical information database 42, and detect prediction model drift or poor performance. The model assessment module 79 may then determine if the reason for the drift or poor performance of the prediction model is due to one or more of operational data drift, sensor errors, and prediction model errors. The model update module 79 may be configured to generate one or more new training datasets from the operational data in the historical information database 42 (as well as new testing and validation datasets, if needed), and retrain the prediction model 54. The prediction model library 83 may track the prediction models 54 deployed over time along with their metadata, which may include an amount of time over which the prediction model 54 has been used, the performance of the prediction model 54, one or more reasons for a failure of the prediction model 54, new updates applied to the prediction model 54, etc. A notification and management module 85 may inform users of any changes applied to the prediction model 54 and any required next steps.

FIG. 3 depicts a flowchart illustrating an accelerated run-to-failure process 80 that may be used to generate operational data (e.g., run-to-failure data) suitable for defining a training dataset. In block 82, the process 80 may operate the machine 14 in a predetermined manner. This operation may include causing the motor 22 to rotate the cutting tool 34 at a predetermined speed, and may also include causing the table 18 to move the workpiece 28 in a predetermined manner. While the machine 14 is operating, the process 80 may proceed to block 84 and collect operational data from the machine 14. The operational data may include, for example, data indicative of a vibration, a power consumption of the motor 22, an amount of torque or speed produced by the motor 22, a position, movement, or force applied to the workpiece 28 by the cutting tool 34, or any other suitable operational data. In block 86, the operational data may be compared to a failure criterion or criteria. Failure criteria may include, for example, detection of a vibration having one or more characteristics that satisfy one or more failure criteria. Exemplary characteristics of a signal or dataset that may satisfy a failure criterion can include an amplitude that exceeds an amplitude threshold, a frequency content that matches specified frequency content, a waveform that matches a specified wavelet, or any other suitable feature of the signal or dataset that can be defined as a failure criterion.

In response to the failure criteria not being satisfied (“NO” branch of decision block 86), the process 80 may proceed to block 88 and perform an accelerated wear cycle. The accelerated wear cycle may include an operation configured to damage the component of the machine being tested, such as the spindle bearing 26 of machine 14. By way of example, the damaging operation may include applying a force to the spindle bearing 26, such as by striking the spindle 24 with a hammer. Once the accelerated wear cycle has been performed, the process 80 may return to block 82 to collect additional operational data. Thus, the process 80 may continue to collect operational data and apply accelerated wear to the component in question until the failure criteria is satisfied. In response to the failure criteria being satisfied (“YES” branch of decision block 86), the process 80 may proceed to block 90, store the operational data as run-to-failure data 52 that may be used, for example, as training dataset, and terminate.

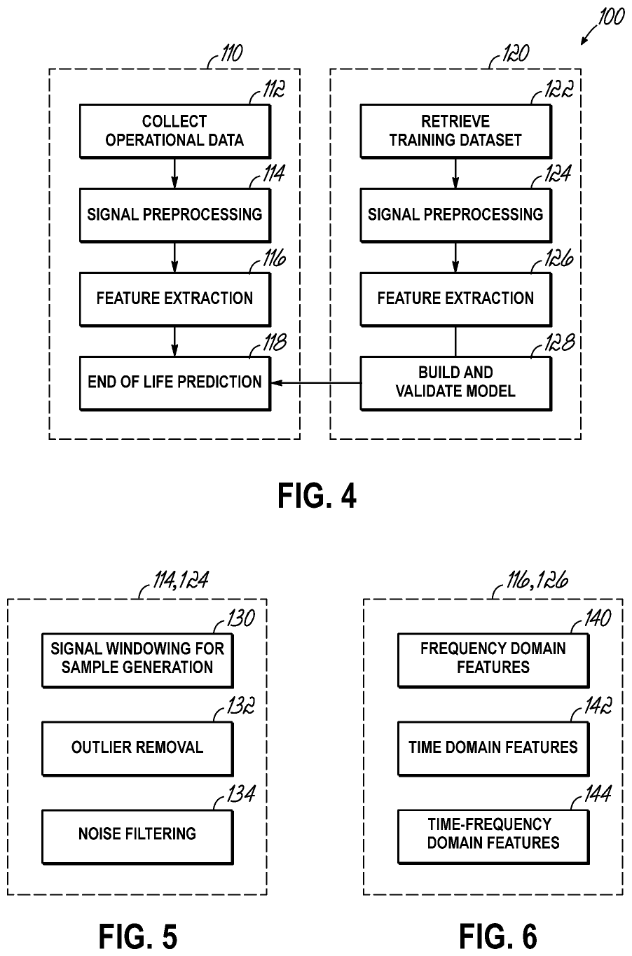

FIG. 4 depicts a flowchart illustrating a model building process 100 that includes a model testing subprocess 110 and a model training subprocess 120. In block 112, the model testing subprocess 110 collects operational data from the machine 14, e.g., while the spindle is rotated at a constant speed. In block 122, the model training subprocess 120 retrieves a training dataset, e.g., from the historical information database 42. In response to receiving their respective data, each subprocess 110, 120 may proceed to respective blocks 114, 124 and perform signal preprocessing on their respective datasets.

Referring now to FIG. 5, and with continued reference to FIG. 4, each of the signal preprocessing blocks 114, 124 may include signal windowing for sample generation (block 130), outlier removal from the generated samples (block 132), and noise filtering (block 134). Signal samples from one or more windows of time may comprise a dataset. Once the signals have been processed into datasets (e.g., by one or more of sampling, outlier removal, and filtering), each subprocess 110, 120 may proceed to respective blocks 116, 126 and extract features from the datasets.

Referring now to FIG. 6, and with continued reference to FIG. 4, in blocks 116, 126, the respective subprocess 110, 120 may use feature extraction algorithms to decompose the respective datasets into a feature space that can be used to predict the remaining useful life of the component being monitored. As used herein, the term “feature” may refer to a particular characteristic of the dataset generated from one or more signals received from one or more sensors 38. General categories of features that may be extracted from the datasets for use in fault diagnosis and remaining useful life predictions for bearings and other machine components may include frequency domain features (block 140), time domain features (block 142), and time-frequency domain features (block 144). Exemplary methods for extracting these types of features are described below. Feature extraction, analysis, and model building are described in detail by U.S. Pat. No. 8,301,406, issued on Oct. 30, 2012, the disclosure of which is incorporated by reference herein in its entirety.

By way of example, one time domain feature of a dataset may be the maximum amplitude of the dataset within a given time period. Time domain analysis may be used to analyze stochastic datasets in the time domain, and may involve the comparison of a real-time or collected dataset to a stored dataset.

Frequency domain analysis may include applying a Fourier transform (e.g., a Discrete Fourier Transform (DFT)) to the dataset to separate the waveform into a sum of sinusoids of different frequencies. Other frequency domain analysis tools that may be used to extract features from datasets may include envelope analysis, frequency filters, side band structure analysis, the Hilbert transform, Cepstrum analysis, and wavelet analysis.

One type of time-frequency domain analysis involves using a wavelet transform to generate wavelets that represent a time signal in terms of a finite length or fast decaying oscillating waveform which is scaled and translated to match the input signals represented by the datasets. Wavelet packet analysis may enable extraction of features from datasets that combine non-stationary and stationary characteristics. The resulting representation may contain information both in time and frequency domain, and may achieve better resolution than either a time based analysis or a frequency based analysis.

Specific time domain features that may be extracted from each dataset may include mean, root mean square (RMS), kurtosis, crest factor, skewness, and entropy values. The mean x̅ of a dataset comprising a series of N samples (x₁, x₂, . . . xₙ) may be provided by:

$$\overline{x} = \frac{1}{N} {\sum }_{i}^{N} {x}_{i} \qquad Eqn . 1$$

The RMS of the dataset may be provided by:

$$RMS = \sqrt{\frac{{\sum }_{i}^{N} {( {x}_{i} - \overline{x} )}^{2}}{N}} \qquad Eqn . 2$$

The kurtosis of the dataset may be provided by:

$$\frac{{{Σ}_{i}^{N} ( {x}_{i} - \overline{x} )}^{4}}{N \times {RMS}^{4}} \qquad Eqn . 3$$

The crest factor of the dataset may be provided by:

$$\frac{max ( {x}_{i} ) - min ( {x}_{i} )}{RMS} \qquad Eqn . 4$$

The skewness of the dataset may be provided by:

$$\frac{{{Σ}_{i}^{N} ( {x}_{i} - \overline{x} )}^{3}}{N \times {RMS}^{3}} \qquad Eqn . 5$$

And the entropy of the dataset may be provided by:

$$- {\sum }_{i = 1}^{N} ( {x}_{i} log ( {x}_{i} ) ) \qquad Eqn . 6$$

A Fourier transform may be used to separate a dataset into a sum of sinusoids of different frequencies for frequency analysis. When dealing with a discrete signal, the Discrete Fourier Transform (DFT) may be used to provide the time-to-frequency transformation. The forward DFT of a finite-duration dataset x[n] (with N samples) may be provided by:

$$X ( k ) {\sum }_{n = 0}^{N - 1} x [ n ] {e}^{- i 2 π \frac{kn}{N}} = {\sum }_{n = 0}^{N - 1} x [ n ] \times [ cos ( \frac{2 π}{N} kn ) - i \times sin ( \frac{2 π}{N} kn ) ] \qquad Eqn . 7$$

In practice, the DFT may be computed more efficiently using a Fast-Fourier Transform (FFT) algorithm.

The Fourier transform translates datasets representing sampled time domain signals received from sensors 38 into the equivalent frequency domain representation. The resulting frequency spectrum may be subdivided into a specific number of sub-bands. By way of example, in cases where the monitored component is a bearing, the center frequency of each sub-band may be pre-defined as a bearing defect frequency. Exemplary bearing defects having defined sub-bands may include Ball Passing Frequency Inner-race (BPFI), Ball Passing Frequency Outer-race (BPFO), Ball Spin Frequency (BSF), and Foundation Train Frequency (FTF). The energy in each of these sub-bands centered at BPFI, BPFO and BSF may be determined and used to make a remaining useful life prediction (block 118 of subprocess 110) or build and validate a prediction model (block 128 of subprocess 120), for example.

The Hilbert transform may be used for further analysis of a signal on a certain characteristic frequency. The Hilbert transform is defined as:

$$H \vert x ( t ) \vert = \frac{1}{π} {\int }_{- ∞}^{∞} \frac{x ( t )}{t - τ} d τ \qquad Eqn . 8$$

where τ is a dummy time variable, x(t) is the time domain signal, and H|x(t)| is the Hilbert transform of x(t).

Sustained mechanical defects often produce narrow-band signals. Thus, a Fourier-based analysis may be useful for extraction of these features. For intermittent defects, signals may demonstrate a non-stationary and transient nature. Wave packet analysis may provide useful tools for detecting these types of intermittent defects. For example, a wavelet packet transform using a library of redundant base wavelets with arbitrary time and frequency resolution may enable the extraction of features from signals that combine non-stationary and stationary characteristics. Wave packet analysis may rely on a wavelet transform that provides a complete level-by-level decomposition of the signal being analyzed. The wavelet packets may be particular linear combinations of wavelets that inherit properties such as orthogonality, smoothness, and time-frequency localization from their corresponding wavelet functions.

A wavelet packet may be represented by a function having three indices:

ψ_{j,k}ⁱ(t) Eqn. 9

where i is an oscillation parameter, j is a scale parameter, and k is a translation parameter. The wavelet packet function may be represented by the following equation:

$${ψ}_{j , k}^{i} ( t ) = {2}^{\frac{j}{2}} {ψ}^{i} ( {2}^{j} t - k ) \qquad Eqn . 10$$

The first wavelet may be referred to as a “mother wavelet”. Wavelets for i=2, 3, . . . may be provided by the following recursive relationships:

$$\begin{matrix}{ψ}^{2 i} ( t ) = \sqrt{2} {\sum }_{- ∞}^{∞} h ( k ) {ψ}^{i} ( 2 t - k ) & Eqn . 11 \\ {ψ}^{2 i + 1} ( t ) = \sqrt{2} {\sum }_{- ∞}^{∞} g ( k ) {ψ}^{i} ( 2 k - k ) & Eqn . 12\end{matrix}$$

where h(k) and g(k) are the quadrature mirror filters associated with the predefined scaling function and the mother wavelet function. The wavelet packet coefficients of a function f may be computed by taking the inner product of the signal and the particular basis function as shown by:

c_{j,k}ⁱ= [symbol] f, ψ_{j,k}ⁱ(t) [symbol] =∫_{-∞}^{∞}f(t)ψ_{j,k}ⁱ(t)dt Eqn. 13

The wavelet packet node energy e_{j,k} may be defined as:

$${e}_{j , k} = {\sum }_{k} {c}_{j , k}^{{i}^{2}} \qquad Eqn . 14$$

The wavelet packet node energies may be used as the input feature space for performance assessments based on wavelet packet analysis. Wavelet packet analysis may be applied to extract features from the non-stationary vibration data. Other types of analyzing wavelet functions may also be used.

With continued reference to FIG. 4, in block 128, the subprocess 120 may build a prediction model for predicting remaining useful life of a component in the machine 14. This model may be built using self-organizing map machine learning model, and employ minimum quantization error to identify matching input vectors.

Self-organizing maps may be used to convert complex relationships in a high-dimensional input space into simple geometric relationships on a low-dimensional output space while preserving the topology. The term “self-organizing” refers to the ability of the underlying neural network to organize itself according to the nature of the input data. The input data vectors may closely resemble each other, and may be located next to each other on the map after training. An n-dimensional input data space x may be denoted by:

x=[x₁, x₂, . . . xₙ]^{T} Eqn. 15

Each neuron j in the neural network may be associated with a weight vector wⱼ having the same dimension as the input space x:

wⱼ=[wⱼ₁, wⱼ₂, . . . wⱼₙ]^{T} Eqn. 16

where j=1, 2, . . . m, and m is the number of neurons in the neural network.

A best matching unit in the self-organizing map may be defined as the neuron whose weight vector wⱼ is closest to the input vector in the input data space x. The Euclidean distance may provide a convenient measure criterion for matching x with wⱼ, with the minimum distance defining the best matching unit. If w_{c} is defined as the weight vector of the neuron that best matches the input vector x, the measure can be represented by:

∥x−w_{c}∥=min{∥x−wⱼ∥}, j=1, 2, . . . , m Eqn. 17

After the best matching unit is identified in the iterative training process, the weight vectors and the topological neighbors of the best matching unit may be updated in order to move them closer to the input vector in the input space. The following learning rule may then be applied:

wⱼ(t+1)=wⱼ(t)+α(t)h_{j,w}_{_{c}}(t) (x−wⱼ(t)) Eqn. 18

where t is the iteration step, and h_{j,w}_{_{c}} denotes the topological neighborhood kernel centered on the best matching unit w_{c}. In an embodiment of the invention, the Gaussian function may be used for the kernel function, as shown by:

$${h}_{j , {w}_{c}} = exp ( \frac{- {d}_{j , {w}_{c}}^{2}}{2 {σ}^{2}} ) \qquad Eqn . 19$$

where d_{j,w}_{_{c}} is the lateral distance between the best matching unit w_{c} and neuron j. The parameter σ may be the “effective width” of the topological neighborhood, and α(t) may be the learning rate, which may be monotonically decreasing with training time. In the initial phase, which may last for a predetermined number of steps (e.g., the first 1000 steps), α(t) may start with a value that is close to 1, and may be linear, exponential, or inversely proportional to t. During a fine-adjustment phase, which may last for the rest of the training, α(t) may keep small values over a long time.

In some cases, only measurement of the normal operating conditions may be available. Under these conditions, a self-organizing map may provide a performance index to evaluate a degradation condition. For each input feature vector, a best matching unit may be found in the self-organizing map trained only with the measurement in the normal operating state. A minimum quantization error may be defined as a distance between the input feature vector and the weight vector of the best matching unit. The minimum quantization error may actually indicate how far away the input feature vector deviates from the normal operating state. The minimum quantization error MQE may be more particularly defined as:

MQE=∥V_{F}−V_{BMU}∥ Eqn. 20

where V_{F} is the input feature vector, and V_{BMU} is the weight vector of the best matching unit. The degradation trend may thereby be measured by the trend of the minimum quantization error.

FIG. 7 depicts a graph 150 including a plots 152, 154 of minimum quantization error MQE versus number of accelerated wear cycles (e.g., hits with a hammer) on the spindle 24 of machine 14. Plots 152, 154 may depict a “life cycle trajectory” for the machine 14 or a component thereof, e.g., the spindle bearing 26. Plot 152 may represent an unfiltered minimum quantization error MQE, and plot 154 may represent a smoothed minimum quantization error MQE. Early in the accelerated run-to-failure process, plots 152, 154 may be in a baseline region 156 in which the minimum quantization error MQE has a low value indicative of a relatively undamaged spindle bearing 26. As the accelerated wear cycles accumulate, the minimum quantization error MQE initially increases. However, after about 120 accelerated wear cycles, the plots 154, 156 enter a self-healing region 158 during which the minimum quantization error MQE drops. Finally, after about 190 accelerated wear cycles, the minimum quantization error MQE increases rapidly, and the plots 152, 154 enter a failure region 160.

Degradation assessment may be used to evaluate an overlap between the feature vector input into the prediction model, and the feature vector extracted from datasets generated during normal operation of the machine 14. A quantitative measure may be calculated to indicate the degradation of the machine 14. To this end, the self-organizing map may be used to generate a performance index to evaluate the degradation status based on a deviation from the baseline of normal condition. The self-organizing map may provide a classification and visualization tool which can convert a multidimensional feature space into a one or two-dimensional space, such as a two-dimensional graph. One type of graph that may be generated using the self-organizing map is commonly referred to as a “health map” in which different areas represent different failure modes for diagnosis purposes.

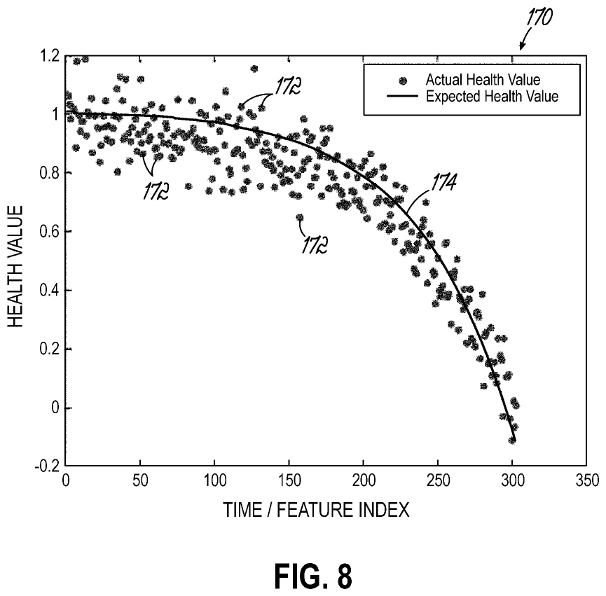

FIG. 8 depicts an exemplary health map 170 including a plurality of datapoints 172 representing measured health values each quantifying a health condition of the machine 14 or a component thereof (e.g., the spindle bearing 26), and a plot 174 of predicted health values representing the output of a remaining useful life prediction model. As can be seen, the measured health values generally track the predicted health values, demonstrating the ability of the self-organizing map to predict a remaining useful life for the monitored component.

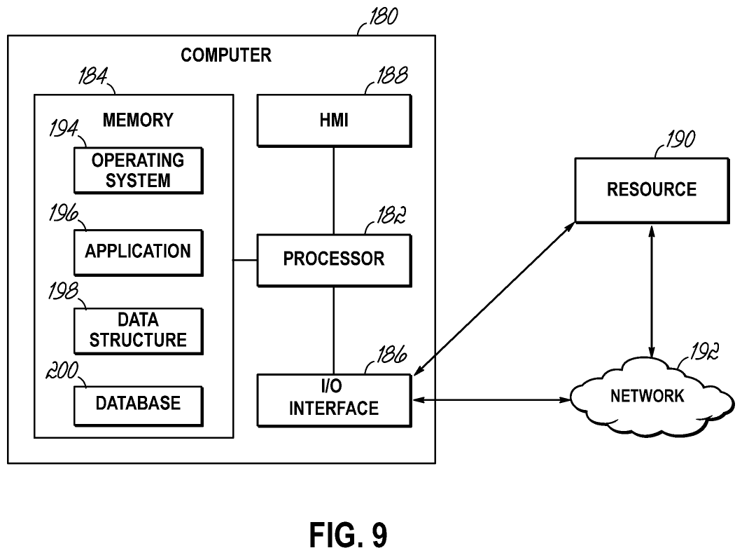

Referring now to FIG. 9, embodiments of the invention described above, or portions thereof, may be implemented using one or more computer devices or systems, such as exemplary computer 180. The computer 180 may include a processor 182, a memory 184, an input/output (I/O) interface 186, and a Human Machine Interface (HMI) 188. The computer 180 may also be operatively coupled to one or more external resources 190 via a network 192 or I/O interface 186. External resources may include, but are not limited to, servers, databases, mass storage devices, peripheral devices, cloud-based network services, or any other resource that may be used by the computer 180.

The processor 182 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions stored in memory 184. Memory 184 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 182 may operate under the control of an operating system 194 that resides in memory 184. The operating system 194 may manage computer resources so that computer program code embodied as one or more computer software applications, such as an application 196 residing in memory 184, may have instructions executed by the processor 182. One or more data structures 198 may also reside in memory 184, and may be used by the processor 182, operating system 194, or application 196 to store or manipulate data.

The I/O interface 186 may provide a machine interface that operatively couples the processor 182 to other devices and systems, such as the external resource 190 or the network 192. The application 196 may thereby work cooperatively with the external resource 190 or network 192 by communicating via the I/O interface 186 to provide the various features, functions, applications, processes, or modules comprising embodiments of the invention. The application 196 may also have program code that is executed by one or more external resources 190, or otherwise rely on functions or signals provided by other system or network components external to the computer 180. Indeed, given the nearly endless hardware and software configurations possible, persons having ordinary skill in the art will understand that embodiments of the invention may include applications that are located externally to the computer 180, distributed among multiple computers or other external resources 190, or provided by computing resources (hardware and software) that are provided as a service over the network 192, such as a cloud computing service.

The HMI 188 may be operatively coupled to the processor 182 of computer 180 to allow a user to interact directly with the computer 180. The HMI 188 may include video or alphanumeric displays, a touch screen, a speaker, and any other suitable audio and visual indicators capable of providing data to the user. The HMI 188 may also include input devices and controls such as an alphanumeric keyboard, a pointing device, keypads, pushbuttons, control knobs, microphones, etc., capable of accepting commands or input from the user and transmitting the entered input to the processor 182.

A database 200 may reside in memory 184, and may be used to collect and organize data used by the various systems and modules described herein. The database 200 may include data and supporting data structures that store and organize the data. In particular, the database 200 may be arranged with any database organization or structure including, but not limited to, a relational database, a hierarchical database, a network database, or combinations thereof. A database management system in the form of a computer software application executing as instructions on the processor 182 may be used to access the information or data stored in records of the database 200 in response to a query, which may be dynamically determined and executed by the operating system 194, other applications 196, or one or more modules.

In general, the routines executed to implement the embodiments of the invention, whether implemented as part of an operating system or a specific application, component, program, object, module or sequence of instructions, or a subset thereof, may be referred to herein as “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the text of the specification, the flowcharts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the text of the specification, flowcharts, sequence diagrams, or block diagrams.

The flowcharts and block diagrams depicted in the figures illustrate the architecture, functionality, or operation of possible implementations of systems, methods, or computer program products according to various embodiments of the invention. In this regard, each block in the flowchart or block diagrams may represent a module, segment, or portion of instructions, which comprises one or more executable instructions for implementing the specified logical function or functions.

In certain alternative embodiments, the functions, acts, or operations specified in the text of the specification, the flowcharts, sequence diagrams, or block diagrams may be re-ordered, processed serially, or processed concurrently consistent with embodiments of the invention. Moreover, any of the flowcharts, sequence diagrams, or block diagrams may include more or fewer blocks than those illustrated consistent with embodiments of the invention. It should also be understood that each block of the block diagrams or flowcharts, or any combination of blocks in the block diagrams or flowcharts, may be implemented by a special purpose hardware-based system configured to perform the specified functions or acts, or carried out by a combination of special purpose hardware and computer instructions.

The terminology used herein is for the purpose of describing particular embodiments only and is not intended to be limiting of the embodiments of the invention. As used herein, the singular forms “a”, “an” and “the” are intended to include both the singular and plural forms, and the terms “and” and “or” are each intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for estimating a health of a machine, comprising:
one or more processors; and
a memory coupled to the one or more processors and including program code that, when executed by the one or more processors, causes the system to:
collect first operational data from a first machine;
determine a measured health value based on the first operational data;
compare the measured health value to a predicted health value generated by a first prediction model;
determine an error based at least in part on the comparison of the measured health value to the predicted health value;
in response to the error exceeding a predetermined threshold, define a second prediction model based on the first operational data; and
replace the first prediction model with the second prediction model.

2. The system of claim 1, wherein the first machine is one of a plurality of machines, and the program code further causes the system to:
generate the measured health value for each machine of the plurality of machines based on the first operational data from the respective machine;
compare each of the measured health values to a respective predicted health value generated by the first prediction model; and
determine the error based on each of the comparisons between the measured health values and the predicted health values.

3. The system of claim 2, wherein the error is a root mean square error.

4. The system of claim 2, wherein:
each machine is monitored constantly over time to capture a natural degradation of one or more components,
a network of machines is created to share data through a central server,
the central server is used for performance assessment, construction of new degradation patterns, and for updating the first prediction model,
a set of peer-to-peer comparisons and real-time tests are conducted to assess data or model drift;
a data and model governance system is used to update the degradation pattern and the first prediction model within a network of machines in real-time and autonomously, and
a notification and management module is used for user interactions, publishing notifications, and for organizing analytic queries to a dashboard.

5. The system of claim 1, wherein the program code further causes the system to:
operate the first machine in a predetermined manner;
collect second operational data from the first machine;
compare the second operational data to a failure criterion;
in response to the second operational data not satisfying the failure criterion, perform an accelerated wear cycle on a first component of the first machine;
in response to the second operational data satisfying the failure criterion, generate a training dataset based on the second operational data; and
iteratively operate the first machine in the predetermined manner, collect the second operational data from the first machine, compare the second operational data to the failure criterion, and perform the accelerated wear cycle until the second operational data satisfies the failure criterion.

6. The system of claim 5, wherein the first machine includes a motor operatively coupled to a spindle, and operating the first machine in the predetermined manner includes causing the motor to rotate the spindle at a predetermined speed.

7. The system of claim 5, wherein the first machine includes a motor operatively coupled to a spindle, and the second operational data includes data indicative of one or more of a vibration, a power consumption of the motor, a speed of the motor, an amount of torque generated by the motor, a position of the spindle, a movement of the spindle, and a force applied to the spindle.

8. The system of claim 5, wherein the failure criterion includes detecting one or more of a vibration having an amplitude that exceeds an amplitude threshold, a frequency content that matches a specified frequency content, and a waveform that matches a specified wavelet.

9. The system of claim 5, wherein the first machine includes a spindle, and the program code causes the system to perform the accelerated wear cycle on the first component by applying a force to the spindle.

10. The system of claim 9, wherein the force is applied by striking the spindle with a hammer.

11. The system of claim 5, wherein the program code further causes the system to:
extract one or more features from the training dataset; and
define the first prediction model based on the one or more features.

12. The system of claim 11, wherein the one or more features include one or more of a frequency domain feature, a time domain feature, and a time-frequency domain feature.

13. The system of claim 11, wherein the program code further causes the system to:
operate a second machine;
collect third operational data from the second machine;
extract the one or more features from the third operational data; and
input the one or more features extracted from the third operational data into the first prediction model to estimate the remaining useful life of a second component of the second machine.

14. A method of estimating a health of a machine, comprising:
collecting first operational data from a first machine;
determining a measured health value based on the first operational data;
comparing the measured health value to a predicted health value generated by a first prediction model;
determining an error based at least in part on the comparison of the measured health value to the predicted health value;
in response to the error exceeding a predetermined threshold, defining a second prediction model based on the first operational data; and
replacing the first prediction model with the second prediction model.

15. The method of claim 14, wherein the first machine is one of a plurality of machines, and further comprising:
generating the measured health value for each machine of the plurality of machines based on the first operational data from the respective machine;
comparing each of the measured health values to a respective predicted health value generated by the first prediction model; and
determining the error based on each of the comparisons between the measured health values and the predicted health values.

16. The method of claim 15, wherein the error is a root mean square error.

17. The method of claim 14, further comprising:
operating the first machine in a predetermined manner;
collecting second operational data from the first machine;
comparing the second operational data to a failure criterion;
in response to the second operational data not satisfying the failure criterion, performing an accelerated wear cycle on a first component of the first machine;
in response to the second operational data satisfying the failure criterion, generating a training dataset based on the second operational data; and
iteratively operating the first machine in the predetermined manner, collecting the second operational data from the first machine, comparing the second operational data to the failure criterion, and performing the accelerated wear cycle until the second operational data satisfies the failure criterion.

18. The method of claim 17, wherein the first machine includes a motor operatively coupled to a spindle, and operating the first machine in the predetermined manner includes causing the motor to rotate the spindle at a predetermined speed.

19. The method of claim 17, wherein the first machine includes a motor operatively coupled to a spindle, and the second operational data includes data indicative of one or more of a vibration, a power consumption of the motor, a speed of the motor, an amount of torque generated by the motor, a position of the spindle, a movement of the spindle, and a force applied to the spindle.

20. The method of claim 17, wherein the failure criterion includes detecting one or more of a vibration having an amplitude that exceeds an amplitude threshold, a frequency content that matches a specified frequency content, and a waveform that matches a specified wavelet.

21. The method of claim 17, wherein the first machine includes a spindle, and performing the accelerated wear cycle on the first component includes applying a force to the spindle.

22. The method of claim 21 wherein the force is applied by striking the spindle with a hammer.

23. The method of claim 17, further comprising:
extracting one or more features from the training dataset; and
defining the first prediction model based on the one or more features.

24. The method of claim 23, wherein the one or more features include one or more of a frequency domain feature, a time domain feature, and a time-frequency domain feature.

25. The method of claim 23, further comprising:
operating a second machine;
collecting third operational data from the second machine;
extracting the one or more features from the third operational data; and
inputting the one or more features extracted from the third operational data into the first prediction model to estimate the remaining useful life of a second component of the second machine.

26. The method of claim 17, wherein the first component of the first machine is a spindle bearing.

27. A computer program product for estimating a health of a machine, comprising:
a non-transitory computer-readable storage medium; and
program code stored on the non-transitory computer-readable storage medium that, when executed by one or more processors, causes the one or more processors to:
collect first operational data from a first machine;
determine a measured health value based on the first operational data;
compare the measured health value to a predicted health value generated by a first prediction model;
determine an error based at least in part on the comparison of the measured health value to the predicted health value;
in response to the error exceeding a predetermined threshold, define a second prediction model based on the first operational data; and
replace the first prediction model with the second prediction model.
